(19) United States
(12) Patent Application Publication
(10) Pub. No.: US 2022/0288891 A1
(43) Pub. Date: Sep. 15, 2022

(54) Composite Board

(71) Applicant: JENG FENG SHUTTLE & BOBBIN CO., LTD., Taichung City (TW)

(72) Inventor: Chin-Tsai Chen, Taichung City (TW)

(21) Appl. No.: 17/195,801

(22) Filed: Mar. 9, 2021

(51) Int. Cl. B32B 13/10; B32B 7/12

(52) U.S. Cl. CPC B32B 13/10; B32B 7/12; B32B 2307/3065; B32B 2307/7265; B32B 2419/00; E04B 1/942

(57) ABSTRACT

A composite board includes a fireproof layer and a first plank layer arranged on the fireproof layer. The fireproof layer has a first thickness. The first plank layer has a second thickness. The first plank layer is stuck to the fireproof layer by waterproof glue.

### BACKGROUND OF THE INVENTION

### 1. Field of the Invention

The present invention relates to a board and, more particularly, to a composite board available for a wall or ground of a building or construction.

### 2. Description of the Related Art

A conventional composite board comprises a flameproof layer to provide a fireproof function. However, the flameproof layer is brittle and cannot be erected easily. Thus, when the conventional composite board is attached to a wall, the flameproof layer is easily cracked or broken due to hit during erection, thereby failing the conventional composite board. In addition, the conventional composite board has a heavy weight and an expensive price. Further, the conventional composite board is not resistant to the moisture so that it is not available for a humid area.

### BRIEF SUMMARY OF THE INVENTION

The primary objective of the present invention is to provide a composite board that is fireproof, waterproof, and bug-proof.

Another objective of the present invention is to provide a composite board that has a light weight.

A further objective of the present invention is to provide a composite board that has a stiff structure and a reinforced structural strength.

A further objective of the present invention is to provide a composite board that has an inexpensive price.

A further objective of the present invention is to provide a composite board that is moisture-proof A further objective of the present invention is to provide a composite board that is erected easily.

A further objective of the present invention is to provide a composite board that has an enhanced aesthetic quality.

In accordance with the present invention, there is provided a composite board comprising a fireproof layer and a first plank layer arranged on the fireproof layer. The fireproof layer has a first thickness. The first plank layer has a second thickness. The first plank layer is stuck to the fireproof layer by waterproof glue. The composite board further comprises a second plank layer sandwiched between the fireproof layer and the first plank layer. The second plank layer has a third thickness. The third thickness of the second plank layer is less than the second thickness of the first plank layer. The first plank layer is stuck to the second plank layer by waterproof glue. The second plank layer is stuck to the fireproof layer by waterproof glue. The first plank layer is provided with a first grain. The second plank layer is provided with a second grain. The first grain of the first plank layer is non-parallel with the second grain of the second plank layer.

According to the primary advantage of the present invention, the fireproof layer of the composite board is fireproof and is resistant to flame.

According to another advantage of the present invention, the first plank layer and the fireproof layer are combined by the waterproof glue so that the composite board is moisture-proof or damp-proof.

According to a further advantage of the present invention, the first grain of the first plank layer and the second grain of the second plank layer are directed toward two different directions to greatly reinforce the structural strength of the composite board.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a composite board in accordance with the first preferred embodiment of the present invention.

FIG. 2 is a perspective view of the composite board in accordance with the first preferred embodiment of the present invention.

FIG. 3 is an exploded perspective view of a composite board in accordance with the second preferred embodiment of the present invention.

FIG. 4 is a perspective view of the composite board in accordance with the second preferred embodiment of the present invention.

FIG. 5 is an exploded perspective view of a composite board in accordance with the third preferred embodiment of the present invention.

### DETAILED DESCRIPTION OF THE INVENTION

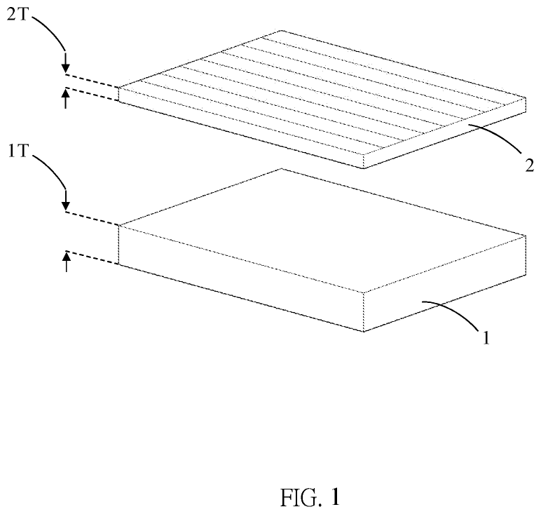

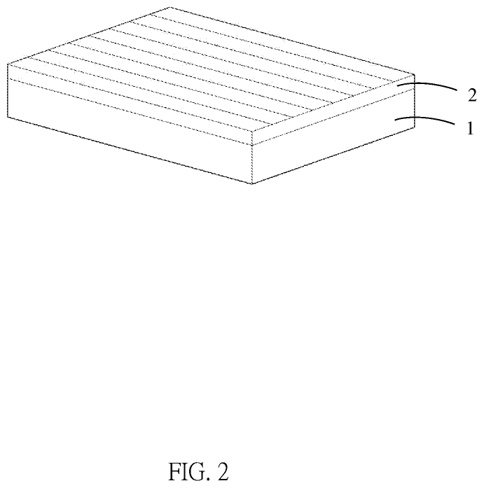

Referring to the drawings and initially to FIGS. 1 and 2, a composite board in accordance with the present invention comprises a fireproof (or fire-resistant or refractory) layer 1 and a first plank (or plate or sheet) layer 2 arranged on the fireproof layer 1. The fireproof layer 1 has a first thickness 1T. The first plank layer 2 has a second thickness 2T. The first plank layer 2 is stuck to (or bonded onto) the fireproof layer 1 by waterproof glue which is arranged between the first plank layer 2 and the fireproof layer 1.

In the preferred embodiment of the present invention, the fireproof layer 1 is a plank made of flame-resistant material of class (or grade or level) one, including magnesium oxide, calcium silicate, silicon dioxide (or silica), Aersio, gypsum, cement, artificial pozzolana, fiber cement, ceramic tile, floor tile, metal sheet plate, or stone plastic composite (SPC).

In the preferred embodiment of the present invention, the first thickness 1T of the fireproof layer 1 is from 0.3 mm to 20 mm.

In practice, when the first thickness 1T of the fireproof layer 1 is less than 0.3 mm, the composite board cannot provide enough strength and sound insulation, and when the first thickness 1T of the fireproof layer 1 is more than 20 mm, the whole weight of the composite board is too heavy. Thus, when the first thickness 1T of the fireproof layer 1 is ranged between 0.3 mm and 20 mm, a balance is achieved between the strength, the sound insulation, and the whole weight of the composite board.

In the preferred embodiment of the present invention, the first plank layer 2 is made of a solid board, a splint or a plywood. The first plank layer 2 covers the fireproof layer 1 to enhance the aesthetic quality of the fireproof layer 1. In addition, the first plank layer 2 reinforces the strength of the fireproof layer 1 which is brittle and has a low tensile resistance.

In the preferred embodiment of the present invention, the second thickness 2T of the first plank layer 2 is from 0.8 mm to 5 mm.

In general, the composite board does not withstand much load when being applied to the wall of the building so that the second thickness 2T of the first plank layer 2 is reduced. On the contrary, the composite board has to withstand much load when being applied to the ground of the building so that the second thickness 2T of the first plank layer 2 is increased.

In practice, when the second thickness 2T of the first plank layer 2 is less than 0.8 mm, the composite board cannot provide enough strength, and when the second thickness 2T of the first plank layer 2 is more than 5 mm, the whole weight of the composite board is too heavy, and the material cost is too high. Thus, when the second thickness 2T of the first plank layer 2 is ranged between 0.8 mm and 5 mm, a balance is achieved between the structural strength, the whole weight, and the material cost of the composite board. In addition, the first plank layer 2 maintains the whole fireproof feature of the composite board.

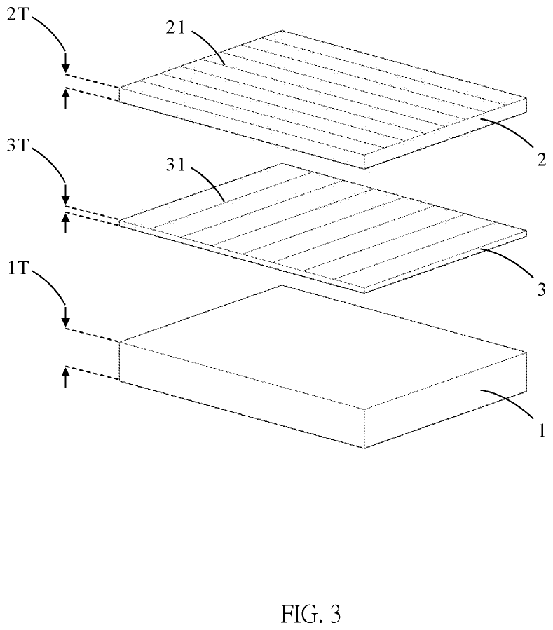

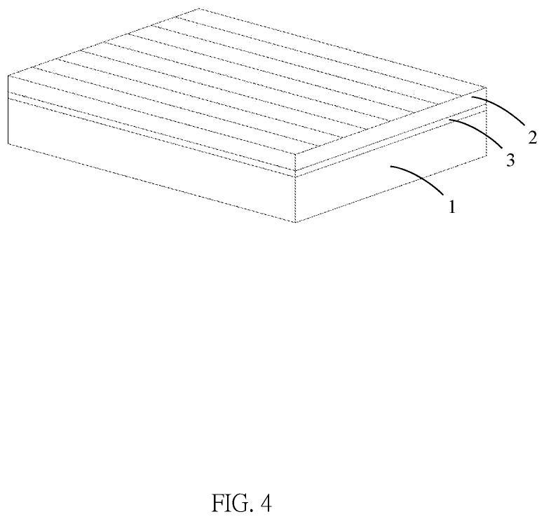

Referring to FIGS. 3 and 4, the composite board of the present invention further comprises a second plank (or plate or sheet) layer 3 sandwiched between the fireproof layer 1 and the first plank layer 2. The second plank layer 3 has a third thickness 3T. The third thickness 3T of the second plank layer 3 is less than the second thickness 2T of the first plank layer 2. The first plank layer 2 is stuck to (or bonded onto) the second plank layer 3 by waterproof glue. The second plank layer 3 is stuck to (or bonded onto) the fireproof layer 1 by waterproof glue.

In the preferred embodiment of the present invention, the first plank layer 2 is provided with a first grain (or texture or pattern) 21, and the second plank layer 3 is provided with a second grain (or texture or pattern) 31. The first grain 21 of the first plank layer 2 is non-parallel with the second grain 31 of the second plank layer 3.

In the preferred embodiment of the present invention, the first grain 21 of the first plank layer 2 is perpendicular to the second grain 31 of the second plank layer 3. The second plank layer 3 is used to reinforce the structural strength of the composite board. Thus, the first grain 21 of the first plank layer 2 and the second grain 31 of the second plank layer 3 are directed toward two different directions to reinforce the structural strength of the composite board in different directions.

In the preferred embodiment of the present invention, the second plank layer 3 is made of a solid board, a splint or a plywood.

In the preferred embodiment of the present invention, the third thickness 3T of the second plank layer 3 is from 0.5 mm to 1.4 mm.

In practice, the first grain 21 of the first plank layer 2 and the second grain 31 of the second plank layer 3 reinforce the structural strength of the composite board, and the third thickness 3T of the second plank layer 3 is less than the second thickness 2T of the first plank layer 2 to reduce the whole weight and the material cost of the composite board. Thus, a balance is achieved between the structural strength, the whole weight, and the material cost of the first plank layer 2 and the second plank layer 3 by the relationship of the second thickness 2T of the first plank layer 2 and the third thickness 3T of the second plank layer 3. In addition, the second plank layer 3 is not made of fireproof material so that when the third thickness 3T of the second plank layer 3 is more than 1.4 mm, the fireproof effect of the composite board is decreased. Thus, when the third thickness 3T of the second plank layer 3 is ranged between 0.5 mm and 1.4 mm, the second plank layer 3 also maintains the whole fireproof feature of the composite board.

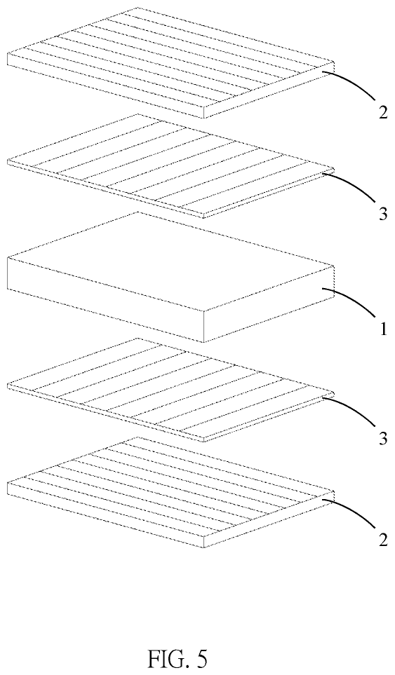

Referring to FIG. 5, the first plank layer 2 and the second plank layer 3 are laminated and are arranged on two opposite faces of the fireproof layer 1. Thus, the first plank layer 2 and the second plank layer 3 largely enhance the structural strength of the fireproof layer 1 to prevent the fireproof layer 1 from being cracked or broken due to hit during erection.

Accordingly, the fireproof layer 1 of the composite board is fireproof and is resistant to flame. In addition, the first plank layer 2 and the fireproof layer 1 are combined by the waterproof glue so that the composite board is moisture-proof or damp-proof. Further, the first grain 21 of the first plank layer 2 and the second grain 31 of the second plank layer 3 are directed toward two different directions to greatly reinforce the structural strength of the composite board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A composite board comprising:
a fireproof layer; and
a first plank layer arranged on the fireproof layer;
wherein:
the fireproof layer has a first thickness;
the first plank layer has a second thickness; and
the first plank layer is stuck to the fireproof layer by waterproof glue.

2. The composite board as claimed in claim 1, further comprising:
a second plank layer sandwiched between the fireproof layer and the first plank layer;
wherein:
the second plank layer has a third thickness;
the third thickness of the second plank layer is less than the second thickness of the first plank layer;
the first plank layer is stuck to the second plank layer by waterproof glue; and
the second plank layer is stuck to the fireproof layer by waterproof glue.

3. The composite board as claimed in claim 2, wherein:
the first plank layer is provided with a first grain;
the second plank layer is provided with a second grain; and
the first grain of the first plank layer is non-parallel with the second grain of the second plank layer.

4. The composite board as claimed in claim 3, wherein the first grain of the first plank layer is perpendicular to the second grain of the second plank layer.

5. The composite board as claimed in claim 1, wherein the first thickness of the fireproof layer is from 0.3 mm to 20 mm.

6. The composite board as claimed in claim 1, wherein the second thickness of the first plank layer is from 0.8 mm to 5 mm.

7. The composite board as claimed in claim 2, wherein the third thickness of the second plank layer is from 0.5 mm to 1.4 mm.

8. The composite board as claimed in claim 1, wherein the fireproof layer is a plank made of flame-resistant material, including magnesium oxide, calcium silicate, silicon dioxide, Aersio, gypsum, cement, artificial pozzolana, fiber cement, ceramic tile, floor tile, metal sheet plate, or stone plastic composite (SPC).
